(19) United States
(12) Patent Application Publication
(10) Pub. No.: US 2009/0215400 A1
(43) Pub. Date: Aug. 27, 2009

(54) PILOT SIGNAL TRANSMISSION MANAGEMENT

(76) Inventors: Henry CHANG, San Diego, CA (US); Doug Dunn, Chula Vista, CA (US); Amit Kalhan, La Jolla, CA (US)

Correspondence Address: KYOCERA WIRELESS CORP., P.O. BOX 928289, SAN DIEGO, CA, 92192-8289, US

(21) Appl. No.: 12/037,768

(22) Filed: Feb. 26, 2008

(51) Int. Cl. H04B 17/00

(52) U.S. Cl. 455/67.14

(57) ABSTRACT

A base station transmits a pilot signal when the presence of a wireless communication device is detected. A wireless device detector receives a detection signal transmitted from a wireless communication device to determine the presence of the wireless communication device.

### RELATED APPLICATIONS

This application is related to U.S. patent application entitled “APPARATUS, SYSTEM AND METHOD FOR INITIATING WLAN SERVICE USING BEACON SIGNALS”, Ser. No. ______, docket number TUTL 00150 and to U.S. patent application entitled “APPARATUS, SYSTEM AND METHOD FOR MANAGING WIRELESS SERVICE TO A WIRELESS COMMUNICATION DEVICE”, Ser. No. ______, docket number TUTL 00168, both filed concurrently with this application and incorporated by reference in their entirety, herein.

### BACKGROUND

The invention relates in general to wireless communication systems and more specifically to managing pilot signal transmission in a wireless communication system.

Base stations in cellular communication systems provide communications services to wireless communication devices within geographical cells where each base station exchanges signals with wireless communication devices within an associated cell. The size and shape of each cell is determined by several factors and are at least partially based on design parameters of the base station. In addition to large macro cells that provide services to numerous devices within relatively large geographical areas, some cellular communication systems are increasingly employing smaller cells to increase efficiency, improve coverage, improve the quality of service, and provide additional services. The smaller cells may include a variety of sizes typically referred to as microcells, picocells and femtocells. Microcells and picocells are often implemented within office buildings, shopping centers and urban areas in order to provide additional security, higher user capacity for the area, additional service features, and/or improved quality of service. Femtocells have relatively smaller geographical areas and are typically implemented at residences or small office locations. Since typical cellular backhaul resources may not be available in these locations, femtocells are sometimes connected to the cellular infrastructure through DSL or cable modems. Femtocells are part of the cellular network and, therefore, communicate with the wireless devices using the same techniques as those used by macrocells. Accordingly, a femtocell base station must also broadcast a pilot signal to enable communications with wireless communication devices. Since femtocells serve only a limited number of authorized users the transmission of a pilot signals from the femtocells are likely to interfere with unauthorized wireless communication devices that are not operating on the particular femtocell. Interference due to pilot signals increases with the number of femtocells within an area.

Accordingly, there is a need for an apparatus, system, and method for managing transmission of pilot signals.

### SUMMARY

A base station transmits a pilot signal when the presence of a wireless communication device is detected. A wireless device detector receives a detection signal transmitted from a wireless communication device to determine the presence of the wireless communication device. Although the base station transmit the pilot in response to detecting the detection signal, the base station may further evaluate the detection signal to determine the proximity of the wireless communication device to the base station and may refrain from transmitting the pilot signal unless the proximity is less than a proximity threshold.

### BRIEF DESCRIPTION OF THE DRAWINGS

FIG. 1 is a block diagram of a communication system in accordance with the exemplary embodiment of the invention.

FIG. 2A is an illustration of an exemplary geographical service area relationship provided by an originating base station and detecting base station where the geographic service area of a detecting base station is within an originating geographic service area of the originating base station.

FIG. 2B is an illustration of an exemplary geographical service area relationship provided by the originating base station and the detecting base station where the geographic service area of a detecting base station overlaps with the originating geographic service area of the originating base station.

FIG. 2C is an illustration of an exemplary geographical service area relationship provided by the originating base station and the detecting base station where the geographic service area of a detecting base station does not overlap with the originating geographic service area of the originating base station.

FIG. 3 is a block diagram of the wireless communication system where the pilot signal is a communication pilot signal having the same frequency (F1) as the frequency (F1) of the communication pilot signal transmitted by the originating base station.

FIG. 4 is a block diagram of the wireless communication system where the pilot signal is a communication pilot signal having a different frequency (F2) from the frequency (F1) of the communication pilot signal transmitted by the originating base station.

FIG. 5 is a block diagram of the wireless communication system where the pilot signal is a beacon pilot signal.

FIG. 6 is a block diagram of an exemplary communication system where the detection signal is an intercepted uplink (reverse link) cellular signal.

FIG. 7 is flow chart of a method of managing wireless service to a wireless communication device 108 where presence of the wireless communication device is determined based on the detection of the detection signal.

FIG. 8 is a flow chart of a method of managing transmission of pilot signals where the detection signal is an uplink signal transmitted by an authorized wireless communication device.

FIG. 9 is a flow chart of a method of managing transmission of pilot signals where the proximity of the wireless communication device to the detecting base station is determined based on the detection signal.

### DETAILED DESCRIPTION

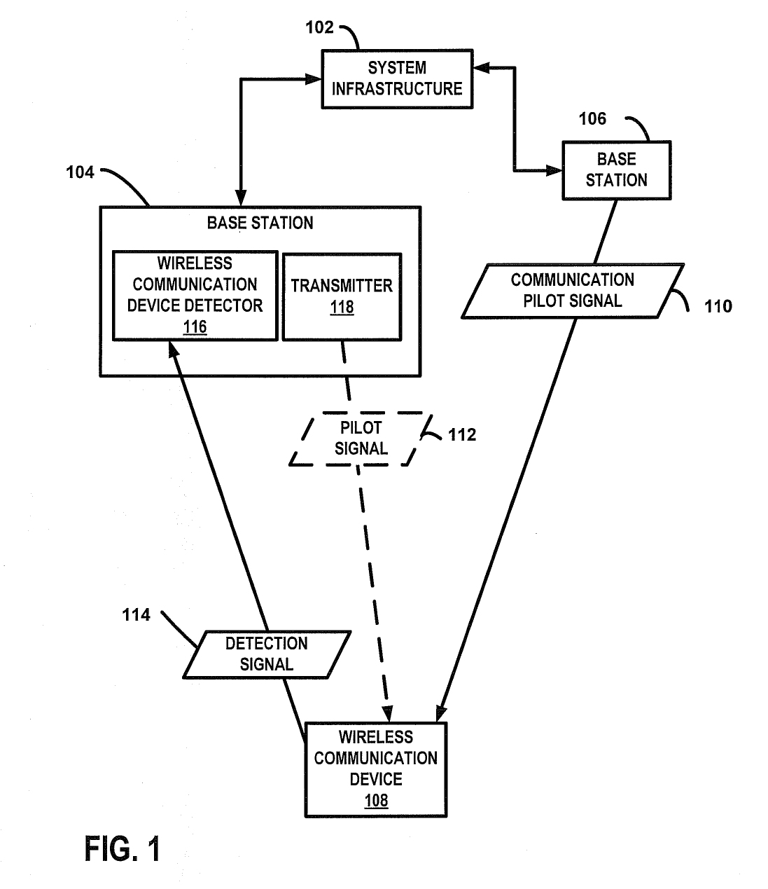

FIG. 1 is a block diagram of a communication system 100 in accordance with an exemplary embodiment of the invention. The communication system 100 may be implemented in accordance with any of numerous technologies and communication standards. In the exemplary embodiment, the system operates in accordance with a Code Division Multiple Access (CDMA) standard such as cdma2000 1X. Examples of other suitable communication standards include other CDMA standards such as 1xEV-DO and W-CDMA, OFDM based standards, and GSM standards. The various functions and operations of the blocks described with reference to the communication system 100 may be implemented in any number of devices, circuits, and/or elements as well as with various forms of executable code such as software and firmware. Two or more of the functional blocks of FIG. 1 may be integrated in a single device and the functions described as performed in any single device may be implemented over several devices. For example, at least portions of the functions of the system infrastructure 102 may be performed by the base station 104, a base station controller, or a Mobile Switching Center (MSC) in some circumstances.

The communication system 100 includes system infrastructure 102 that is connected to one or more base stations 104, 106. Communications between the base stations 104, 106 and wireless communication devices 108 are at least partially managed by the system infrastructure 102. In order for a wireless communication device 108 to communicate with a particular base station, the wireless communication device 108 must adequately receive a communication pilot signal transmitted from the particular base station. Other types of pilot signals however, may be transmitted to assist in handoffs and other functions. For example, beacon pilot signals are transmitted in some circumstances to facilitate handoffs from one service region to another and/or from one base station to another. Although beacon pilot signals may provide limited information, beacon pilot signals are typically not used as communication pilot signals typically operate on a frequency channel different from the communication pilot signals. As discussed herein, therefore, pilot signals are signals transmitted at a particular frequency and include communication pilot signals and beacon pilot signals. Communication pilot signals are used for communication between the wireless communication devices and base stations and provide information to the wireless communication devices facilitating control and synchronization as well as other communication functions. A communication pilot signal, for example, may provide a timing reference and channel information. Beacon pilot signals are used for facilitating other functions such as detection and handoffs.

For the exemplary situation illustrated in FIG. 1, the wireless communication device 108 is communicating with an originating base station 106 and receiving a communication pilot signal 110 transmitted by the base station 106. The originating base station 106 generates and transmits the communication pilot signal 110 which provides control and timing information to the wireless communication device 108. When the detecting base station 104 detects the presence of the wireless communication device 108, the base station 104 transmits a pilot signal 112. Depending on the particular implementation, the pilot signal 112 may be a communication pilot signal or a beacon pilot signal. Where the pilot signal 112 is a beacon pilot signal, the detecting base station 104 also transmits a communication pilot signal prior to a handoff of the wireless communication device 108 from the originating base station 106 to the detecting base station 104.

Based on a detection signal 114 transmitted by the wireless communication device 108, a wireless communication device detector 116 within the base station 104 detects the presence of a wireless communication device 108 that is authorized to access the base station 104. A transmitter 1 1 8 in the base station 102 does not transmit the pilot signal 104 until the wireless communication device 108 is determined to be sufficiently close to the base station 104 for communication. Accordingly, the arrow and block representing the transmission of the pilot signal 112 are illustrated with dashed lines in FIG. 1 to indicate that the pilot signal 112 is not continuously transmitted. In some circumstances, the detection of the detection signal 114 by the wireless communication device 116 detector is sufficient to determine that the wireless communication device 108 is present and that the pilot signal 112 should be transmitted. Therefore, the characteristic of the detection signal 114 may be any of numerous parameters with any of numerous thresholds depending on the particular implementation and the characteristic may whether the detection signal 114 is detectable by the base station receiver. Examples of other characteristics include a signal to noise ratio (SNR), bit error rate (BER), power level, signal propagation time, and presence of particular data. In the exemplary embodiment, the characteristic of the signal is the ability of the base station to demodulate and decode the detection signal 114 using a long code mask corresponding to authorized users of the base station.

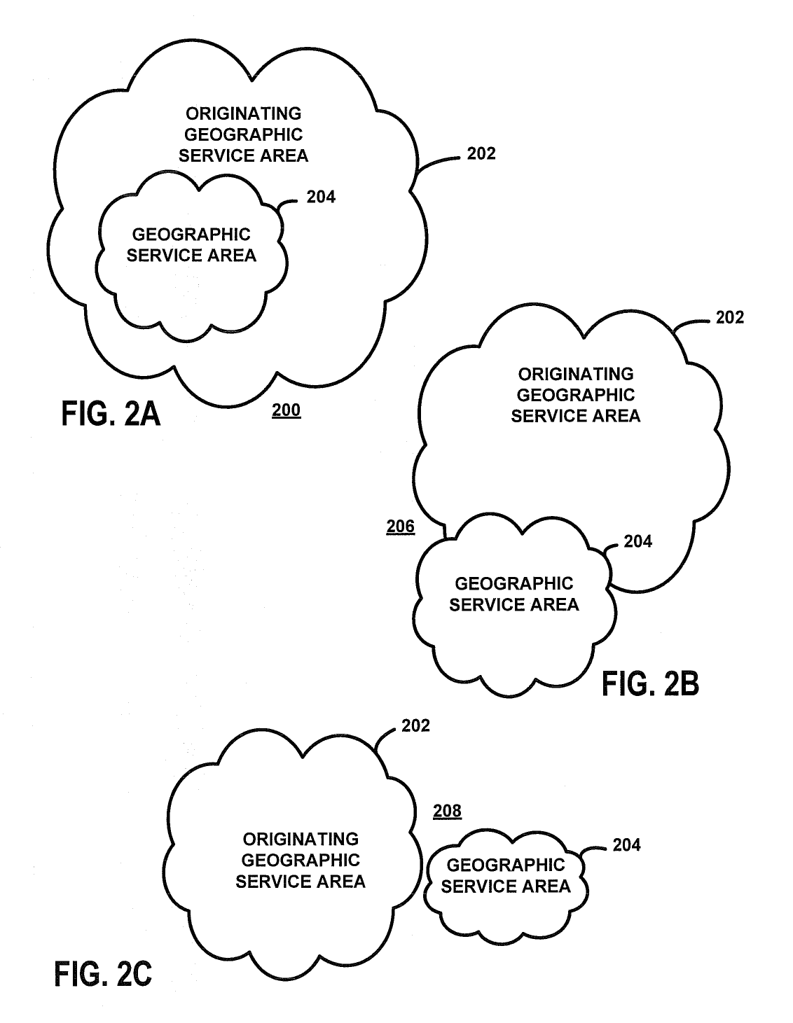

The base stations 104, 106 provide wireless services within geographical services areas sometimes referred to as cells. As discussed below with reference to FIG. 2A, FIG. 2B, and FIG. 2C, the originating base station 106 provides wireless service within a geographical service area that may overlap, completely surround, or be separate from the geographical service area of the base station 104. As discussed below, a suitable implementation of the base station 104 with a device detector 116 is within a cellular communication system where the base station 104 provides wireless communication services within a femtocell to authorized users. The base station 104, however, may be any base station within a communication system that requires a downlink (forward link) pilot signal. The detection signal 114 may be any wireless signal suitable to indicate to the wireless communication device detector 116 at least the presence of the wireless communication device 108. Examples of detection signals 106 include optical signals and radio frequency (RF) signals such as cellular, Bluetooth, Near-Field Communication and WiFi signals. In the exemplary embodiment, the detection signal is a reverse link (uplink) communication signal transmitted in accordance with wireless communications between the wireless communication device and the originating base stations 106. Where the detection signal 114 is signal other than an uplink cellular signal, a common source clock and/or a predetermined transmission schedule may be used. In such an example, therefore, the transmission of the detection signal 114 is synchronized to a clock used by the originating base station and the femtocell base station synchronizes monitoring for the detection signal to a time source synchronized to the same reference as the originating base station clock. Accordingly, the transmission and monitoring of the detection signal is synchronized. As a result, resources for monitoring the channel for the detection signal are minimized. Further, the ability of the femtocell base station to detect the detection signal may improve since the receiver may more easily determine when and how to discriminate this signal from other similar signal sources. In exemplary implementation, the detection signal 114 provides information adequate for the wireless communication device detector 116 to determine that the wireless communication device 108 is an authorized user of the base station 104.

FIG. 2A, FIG. 2B and FIG. 2C are depictions of exemplary geographical service area relationships 200, 206, 208 provided by the originating base station 106 and the base station 104. An originating geographical service area 202 provided by the originating base station 106 and a geographic service area 204 provided by the detecting base station 104 may have any of numerous shapes, sizes, and configurations. Accordingly, the clouds representing the service areas generally illustrate the relationships between the service areas and do not necessarily depict the actual shapes of the service areas. Further, the service areas may contain holes of coverage where service is unavailable. In the interest of clarity and brevity, such features are not illustrated in the figures. In FIG. 2A, the service area 204 of the detecting base station 104 is completely within the service area 202 provided by the originating base station 106. Such service area relationships 200 often occur where some base stations within the communication system provide smaller service regions such as microcell, picocell, and femtocell configurations. A femtocell arrangement, for example, may include a femtocell base station located at a residence where the femtocell is a service area for devices used by device users living at the residence. When the wireless communication devices are outside the service area 204, service is provided by larger macrocells. When the authorized wireless communication device is at the residence, however, service is provided by the base station presenting the smaller femtocell service area 204. Accordingly, in most situations, the service area 204 of the detecting base station 104 will be completely within the service area 202 of the originating base station 106. In some situations, however the service area 204 may be partially overlapping with the service area 202 as shown in FIG. 2B or may be non-overlapping but adjacent to the service area 202 as shown in FIG. 2C.

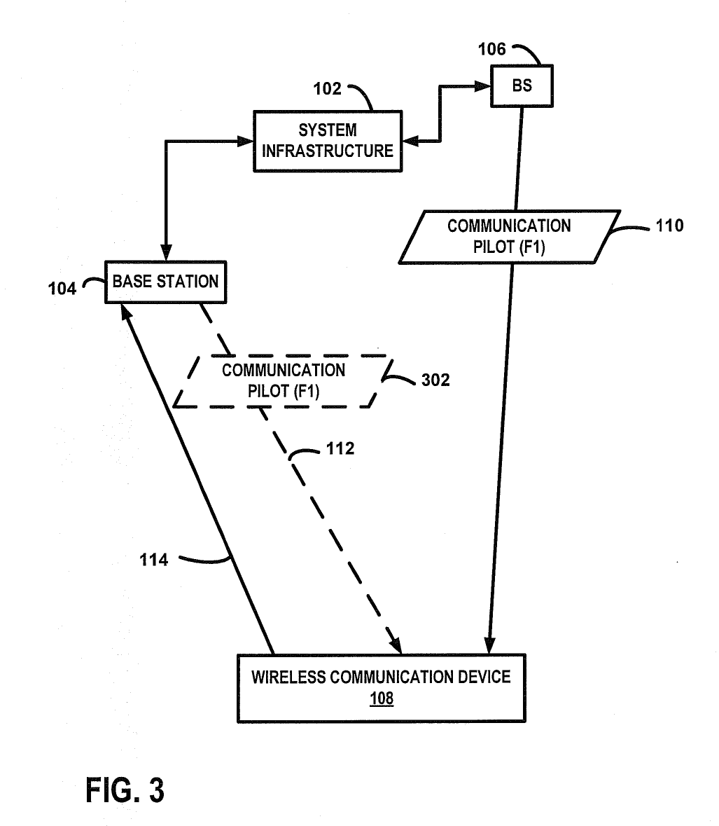

FIG. 3 is a block diagram of the wireless communication system 100 where the pilot signal 112 is a communication pilot signal 302 having the same frequency (F1) as the frequency (F1) of the communication pilot signal 110 transmitted by the originating base station 106. When the detecting base station 104 determines that the wireless communication device is sufficiently close, the base station 104 begins transmitting the communication pilot signal 302 (pilot signal 112). Accordingly, by refraining from transmitting the communication pilot signal 302 until the presence of a wireless communication device 108 is detected by the base station 104, interference to non-authorized devices from the communication pilot signal 110 is minimized. In a CDMA case, the pilot signal 112 may use a scrambling code (or PN Offset) different from that used on the communication pilot signal 110. In addition, a femtocell may coordinate with the network and other femtocells in the region and set a schedule for transmitting each corresponding pilot signal minimizing collisions and reducing interference.

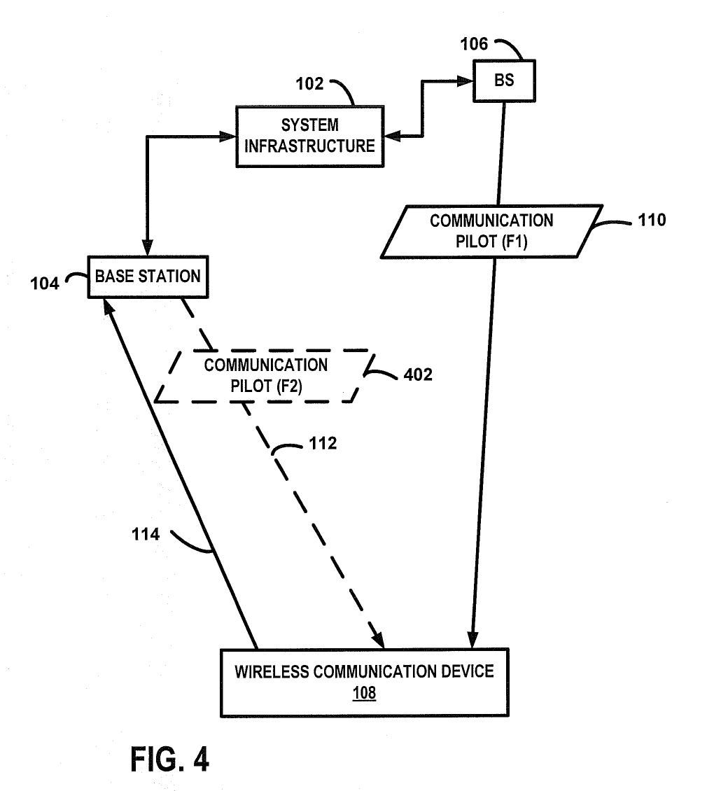

FIG. 4 is a block diagram of the wireless communication system 100 where the pilot signal 112 is a communication pilot signal 402 having a different frequency (F2) from the frequency (F1) of the communication pilot signal 110 transmitted by the originating base station 106. When the detecting base station 104 determines that the wireless communication device is sufficiently close, the base station 104 begins transmitting the communication pilot signal 402 (pilot signal 112). Although the pilot signal 112 has a different frequency than the pilot signal 110, interference in the system 100 is reduced since one or more other base stations in the system 100 may use the same frequency for communication for transmitting a pilot signal. For example, where several femtocell base stations (104) provide services within femtocell service areas that are within a macrocell service area, one or more of the femtocell base stations (104) may use the same frequency (F2) for transmitting the pilot signal 112 although the frequency (F2) is different from the frequency (F1) of the communication pilot signal 110 transmitted by the macrocell base station 106. Accordingly, pilot interference between femtocells is reduced by limiting pilot transmissions to situations where the presence of an authorized wireless communication device is detected. Additionally, limiting pilot transmissions until the detection of an authorized wireless communication device will reduce the likelihood of unauthorized wireless communication devices from acquiring the femtocell base station (104). In a situation where a wireless communication device is “camped on” a femtocell base station and continues to receive the pilot even though the wireless communication device is not authorized to use the femtocell base station, the device will not be able to make any calls and more importantly, will not be able to receive any calls. Limiting pilot transmissions only when authorized devices are detected reduces the likelihood of these situations. In the CDMA case, the pilot signal 112 may use a scrambling code (or PN Offset) different from the code used on the pilot signal 110. In addition, a femtocell may coordinate with the network and other femtocells in the region and set a schedule for transmitting its pilot signal.

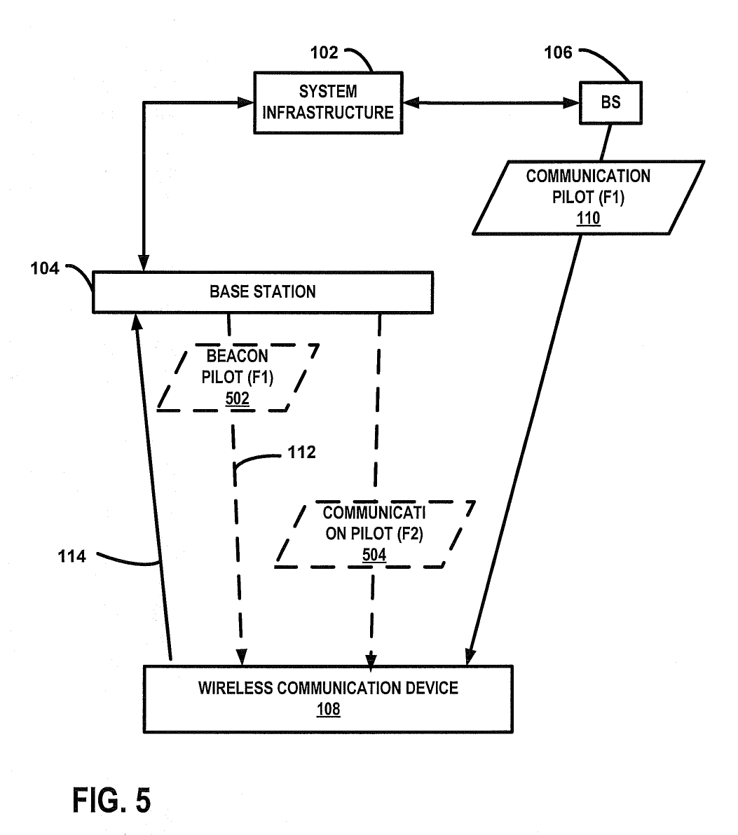

FIG. 5 is a block diagram of the wireless communication system 100 where the pilot signal 11 2 is a beacon pilot signal 502. For the situation illustrated in FIG. 5, the detecting base station 104 transmits a beacon pilot signal 502 (pilot signal 112) having the same frequency (F1) as the frequency (F1) of the communication pilot 110 transmitted from the originating base station 106. In OFDM based beacon transmissions, frequency F1 is one of the tones of a wideband channel. The macro BS is aware of the beacons' timing and tone location of the beacon to avoid, or at least minimize, collisions. The beacon pilot signal 502 is not transmitted until the base station 104 detects the presence of an authorized wireless communication device 108. When the communication device 108 detects the pilot beacon signal 502 a handoff is initiated through the communication system. The detecting base station 104 transmits a communication pilot signal 504 after detecting presence of the authorized wireless communication device 208. The detecting base station 104 may simultaneously begin transmitting the beacon signal 502 and the communication pilot signal 504, In active, or connected state, however, the base station 104 refrains from transmitting the communication pilot signal 504 until receiving information from the network indicating the wireless communication device 108 will be handed off from the originating base station 106 to the detecting base station 104. If the device is in the idle state, the network does not send any information to base station 104 in the exemplary embodiment. For the case of an idle handoff, both the beacon pilot signal 502 and the communication pilot signal 504 will be transmitted when the authorized wireless communication device 108 is detected. Therefore, a typical handoff scenario during the connected state includes the detection of the authorized wireless communication device 108 followed by transmission of a beacon pilot signal 502. The wireless communication device reports the signal quality of the beacon pilot signal 502 received at the device 108 to the system infrastructure 102 and begins a handoff procedure if instructed by the system infrastructure 102. The system infrastructure 102 also informs the detection base station 104 of the handoff triggering the transmission of the communication pilot signal on the appropriate frequency (F2).

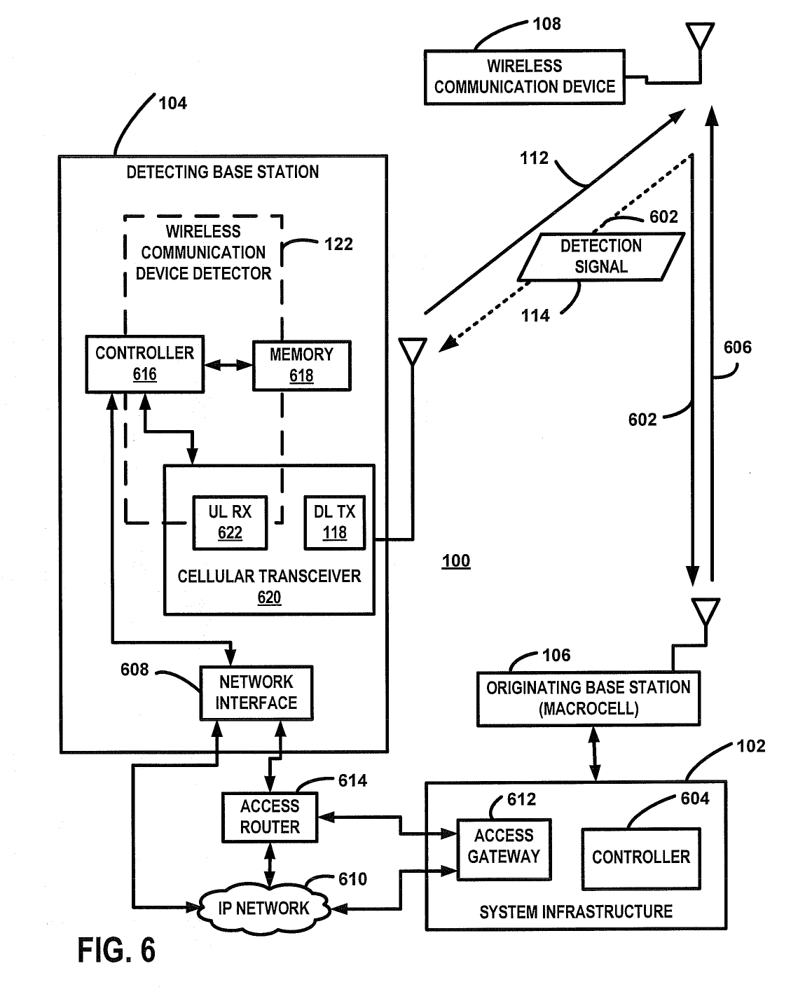

FIG. 6 is a block diagram of an exemplary communication system 100 where the detection signal 114 is an intercepted uplink (reverse link) cellular signal 602. The system 100 may be implemented using any variety of communication technologies and cell sizes. For the example discussed with reference to FIG. 6, the detecting base station 104 provides wireless service within a femtocell and the originating base station 106 provides service within a macrocell. The base stations 104, 106 operate in accordance with CDMA protocols and standards. The term macrocell is used primarily to distinguish this group of diverse technologies from picocells and femtocells that typically have smaller service areas on the order of 100 to 300 feet per base station. Accordingly, the originating base station 106 is any base station that provides wireless communication services within relatively large geographical areas as compared to the femtocell service area provided by the detecting base station in the example of FIG. 6. The functional blocks of FIG. 6 may be implemented using any combination of hardware, software and/or firmware. Two or more of the functional blocks may be integrated in a single device and the functions described as performed in any single device may be implemented over several devices. For example, at least portions of the functions of the system infrastructure 102 may be performed by the base station 106, a base station controller, or an MSC in some circumstances.

The originating base station 106 transmits downlink signals 606 to and receives uplink signals 602 from one or more wireless communication to provide wireless communication service. As discussed herein, wireless communication services refer to any communications, control signaling, pilot signals or other communication that at least partially facilitates operation of the wireless communication device 108. Accordingly, wireless communication services may be provided to the wireless communication device when the device 108 is in an idle state or an active state.

The system infrastructure includes a controller 604 that may be implemented as a mobile switching center (MSC), a combination of an MSC and base station controllers (BSCs), or other similar communication controllers. The controller 604 is connected to the base stations 104,106 through the system infrastructure 102 and manages communications within the system 100. A network interface 608 within the detecting base station 104 facilitates communication with an IP network 610. The network interface 608 provides packet data communications and facilitates access to the Internet and to an access gateway 612 in the system infrastructure 102 through the access router 614 or directly though the IP network 610. The access router 614 may be connected to several base stations 104 and provides communication management and control functions to the base station 104. In some situations, the access router 614 may be implemented within the base station 104 or may be eliminated. In some circumstances, the connection between the access gateway 612 and the base station 104 may include a wireless communication link such as satellite communication link or point-to-point microwave link, for example. Also, in some situations, circuit switched connections may be used to connect the detecting base station 104 to the system infrastructure 102. In a typical arrangement, the detecting base station 104 is connected to the Internet through an Internet Service Provider (ISP) service provided by a digital subscriber line (DSL) or CATV connection. Accordingly, the access router 614 is a DSL modem or cable modem in the typical arrangement. In the exemplary embodiment, therefore, the system infrastructure 110 comprises a packet switched core network that includes at least one access gateway 612. The access gateway 612 is a communication interface that allows the base station 104 to communicate with the system infrastructure 102.

The wireless communication device 108 is any type of communication device that is capable of communicating with the base stations 103, 106. The wireless communication device 106, sometimes referred to as an access terminal, may be a wireless modem, a personal digital assistant, cellular telephone, or other such device.

In addition to the functions and features discussed herein, the detecting base station 104 operates in accordance with the communication protocols of the communication system 100. The base station 104 includes a controller 616, memory 618, cellular transceiver 620 and the network interface 608 in addition to other devices and software for performing the functions of the base station 104. The cellular transceiver 620 includes an uplink receiver 622 and the downlink transmitter 118. For the example in FIG. 6, the wireless communication device detector 122 is implemented by at least portion of the controller 616, memory 618, and uplink receiver 622. Accordingly, the wireless communication device detector 122 is illustrated with a dashed line box to indicate that the detector 122 may include some or all various functions and devices forming the cellular transceiver 620, memory 618 and/or controller 616.

In addition to other information, the memory 618 stores communication device identification values corresponding to each communication device 108 that is authorized to receive service from the base station 104. The communication device identification value may include an electronic serial number (ESN), Mobile station Equipment Identifier (MEID) or International Mobile Subscriber Identity (IMSI) or other unique data identifying the wireless communication device 108. An example of a group of identification values stored in memory includes a collection of ESNs corresponding to the communication devices of the family members of a household where the base station 104 provides service. The identification values may be stored at the base station 104 using any of numerous techniques. An example of a suitable method of storing the values includes storing the values during an initialization procedure performed when the base station 104 is installed. The identification values may be provided, at least partially, by the core network or macro base station. In some implementations, the identification values may be omitted or the base station 104 may allow communication devices that do not have corresponding identification values stored at the base station 104 to receive service from the base station 104. As discussed below, the ESNs are used to generate long code masks such as public long code masks (PLCMs) which allow the detecting base station to receive signals from the wireless communication device 108 having the particular ESN. Other information may be received from the core network to generate the PLCMs in accordance with known techniques. In some situations, the core network, or base station may assign the PLCM to a particular wireless communication device 108. The assigned PLCM value is stored in the base station 104. Also, a private long code mask may be used instead of or in addition to the PLCM in some cases.

During operation, the detecting base station 104 refrains from transmitting a communication pilot signal 112 when no wireless communication device 108 is within service range. The detecting base station 104, however, at least periodically monitors a wireless channel that may include the detection signal 114. The detection signal 114 may be any signal transmitted by the communication device 108, including but not limited to, registration messages, acknowledgement messages, reverse traffic channel data packets and signaling messages. For the example of FIG. 6, the detection base station 104 monitors the reverse link cellular channel used for transmitting signals from wireless communication devices 108 to the originating base station (macrocell base station) 106. The cellular uplink receiver 622 is tuned to the appropriate channel or channels to detect the uplink signal 602 transmitted by the wireless communication device 108. In the exemplary embodiment, the uplink receiver 622 sufficiently demodulates and decodes uplink signals to identify the long code mask. The long code mask is typically a 42 bit binary number that is unique to the wireless communication device 108. In the exemplary embodiment, received signals are compared to a list of long code masks to determine if the signal was transmitted by an authorized wireless communication device 108. As described above, the authorized wireless communication devices are identified by device identifiers stored in memory. The identifiers either directly, or indirectly, correspond to long code masks that facilitate reception of the signals transmitted by the authorized devices in the exemplary embodiment. Typically, the PLCM is derived from a permutation of the bits of the ESN. PLCM may also be based on the Mobile station Equipment Identifier (MEID) or the International Mobile Subscriber Identity (IMSI). The base station 104 evaluates one or more characteristics of the uplink signal to determine if the wireless communication device transmitting the signal is within the service area of the base station or at least whether the device is possibly within the service area of the detecting base station 104. In the exemplary embodiment, the controller 616 determines if the uplink signal 602 can be successfully received. If the signal can be received, the controller 616 determines that the wireless communication device 108 is sufficiently close to receive service from the base station 104. In some cases, the uplink signal may be detected and received even though the wireless communication device 108 is not within the service area of the base station 104. In these circumstances, the wireless communication device 108 may unsuccessfully attempt to acquire service from the base station 104 or the beacon signal may be transmitted from the base station 104 unnecessarily.

In some situations, the determination of whether to transmit the pilot signal may be based on other characteristics of the identification signal in addition to the detection of the signal. For example, the proximity of the wireless communication device 108 to the detecting base station 104 may be calculated or estimated based on characteristics of the detection signal 114 and the pilot signal may be transmitted only when the estimated proximity is less than a proximity threshold. Examples of detection signal characteristics include a signal to noise ratio (SNR), bit error rate (BER), frame error rate (FER), packet error rate (PER), power level, and signal travel time.

The controller 616 determines, or at least estimates, the proximity of the authorized wireless communication device 108 to the detecting base station 104 based on one or more characteristics of the uplink signal. In the exemplary embodiment, the detection of an uplink signal from the communication device 106 is sufficient to determine that the communication device 106 is within a proximity range. The proximity is used to determine whether the communication device 106 is possibly within range of the base station 104 and at least possibly able to receive communication service from the base station 104. Therefore, the controller 204 at least determines whether the communication device is possibly within range of the base station 104. If the controller determines that the wireless communication device is possibly in range, the communication pilot signal 112 is transmitted by the downlink transmitter.

The controller 616 may determine whether to transmit the pilot signal 112 based on factors other than proximity of the wireless communication device 108 or the detection of the detection signal 114. For example, factors may include the available capacity of the detecting base station 104, core network requirements, required bandwidth of the wireless communication device communications, and availability of other base stations or communication service providers in the area. Accordingly, the base station 104 may not transmit the pilot signal even if the wireless communication device is within range in some circumstances. As explained above, a detecting base station may coordinate with the network and other femtocells in the region and set a schedule for transmitting its pilot signal to avoid collisions and reduce interference. In OFDM systems, fractional frequency reuse (FFR) may be coordinated among femtocell base stations to manage resources.

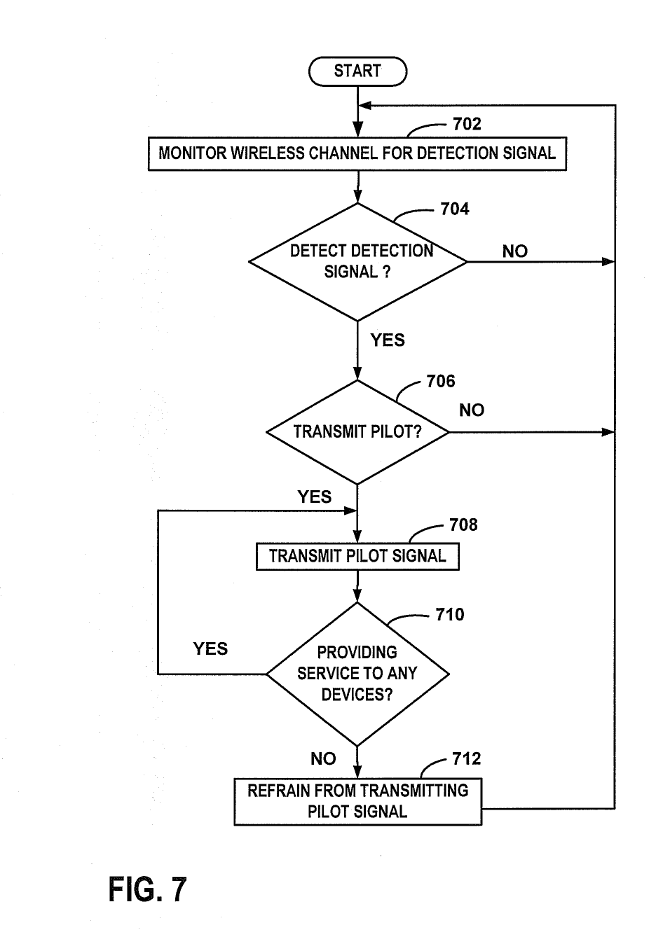

FIG. 7 is flow chart of a method of managing wireless service to a wireless communication device 108 where presence of the wireless communication device is determined based on the detection of the detection signal. The method may be performed by any combination of hardware, software and/or firmware. The order of the steps discussed below may be varied and one or more steps may be performed simultaneously in some circumstances. In the exemplary embodiment, the method is performed, at least in part, by executing code on the controller 616 in the detecting base station 104.

At step 702, the wireless channel that may contain the detection signal is monitored. The wireless communication device detector 122 attempts to demodulate and/or decode incoming signals within the wireless communication channel. In the exemplary embodiment, the uplink receiver (622) is tuned to decode any uplink signals 602 transmitted from any of the communication devices 108 in the user list stored in memory 618. The long code masks derived with the device identification values are applied to incoming signals until an incoming signal is detected. In this implementation, therefore, the incoming uplink signal 602 is the detection signal 114. Where other types of detection signals such as Bluetooth signals are used, the wireless communication device detector may compare a characteristic of the received signals to determine whether a received signal was transmitted by a device within the user list. Accordingly, a Bluetooth signal may include an identification code that corresponds to the device identification values stored in memory 618. In some circumstances, the wireless communication device detector 122 may be configured to monitor all channels for any detection signals.

At step 704, it is determined whether a detection signal 114 has been received. In the exemplary embodiment, the controller 616 determines that a detection signal 114 has been received if an incoming signal can be decoded. In other circumstances, information within the detection signal is applied to the user list to determine whether the received signal has been received from a communication device stored in the user list. If a detection signal 114 has been received, the method continues at step 706. Otherwise, the method returns to step 702 to continue monitoring the wireless channel.

At step 706, it is determined if the pilot signal should be transmitted. In some situations, step can be omitted and the pilot signal may be transmitted when the detection signal is detected. In other situations, however, additional processing or communication is invoked occur before the pilot signal is transmitted. For example, system conditions of the detection base station 104, other base stations, the core network, and/or alternate networks can be evaluated to determine whether a handoff to the detecting base station 104 is desired. Further, the detecting base station may transmit a message to the core network indicating that the identified wireless communication device may be within the service area of the detecting base station 104. The core network may evaluate required bandwidth or other parameters and may provide instructions to the detecting base station on whether the pilot signal should be transmitted. If it is determined that the pilot signal should be transmitted, the method continues at step 708. Otherwise, the method returns to step 702.

At step 708, the pilot signal is transmitted. The pilot signal may be a communication pilot signal or may be a beacon pilot signal in some circumstances. In some situations, both a communication pilot signal and a beacon pilot signal are transmitted.

At step 710, it is determined whether the base station 104 is providing service to any wireless communication devices. If at least one wireless device 108 is communicating with the base station 104, the method returns to step 708 to continue transmitting the pilot signal. If no wireless communication devices 108 are communicating with the base station 104, the base station 104 stops transmitting the pilot signal at step 712 and returns to step 702. Providing wireless service includes providing communication service to devices 108 in active states as well as providing other services to devices in idle states such as, for example, pages from incoming calls, SMS, registration and administrative related services. Accordingly, the detecting base station determines whether any wireless communication devices 108 are in active state and communicating with the detecting base station and also determines if any devices are in the idle state. If the detecting base station determines that there are no active devices 108 within the cell, the base station 104 determines whether any idle devices 108 may still be within the cell. The detecting base station may use any of several methods to determine if devices 108 in the idle state are still within range of the detecting base station 104. One suitable example includes a requiring a time-based registration from idle devices where the wireless communication device 108 periodically registers with the detecting base station. If the detecting base station determines that no idle devices are registering, the base station determines that no devices are receiving wireless service. Another suitable example includes receiving a message from the core network indicating that wireless communication device 108 has registered with another base station such as the originating base station 106. If all previously registered devices are determined to have migrated to other base stations based on the core network messages, the detecting base station 104 determines that no communication devices are receiving wireless service. Another suitable example includes including a request and acknowledgement messaging arrangement where the detecting base station 104 periodically sends an Order Message to devices that may be in an idle state. If no acknowledgement message is received, the detecting base station determines that the device 108 is not longer in the cell. If no previously detected devices 108 are determined to be still within the cell, the detecting base station 104 determines that no wireless communication devices 108 are receiving wireless service and the method continues at step 712 where pilot signal is turned off.

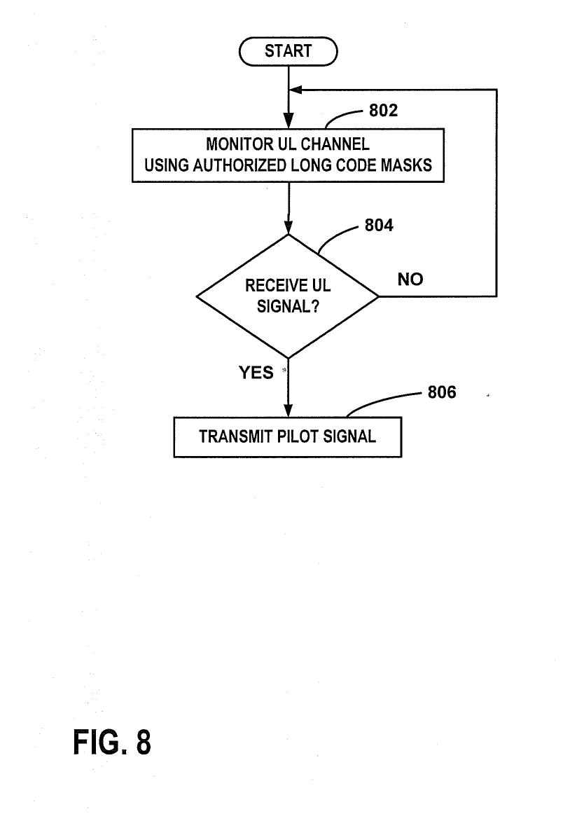

FIG. 8 is a flow chart of a method of managing transmission of pilot signals where the detection signal is an uplink signal transmitted by an authorized wireless communication device 108. The method may be performed by any combination of hardware, software and/or firmware. The order of the steps discussed below may be varied and one or more steps may be performed simultaneously in some circumstances. In the exemplary embodiment, the method is performed, at least in part, by executing code on the controller 616 in the detecting base station 104.

At step 802, the uplink channels are monitored for an uplink signal that is transmitted with a PLCM corresponding to an authorized communication device in the user list. The wireless communication device detector attempts to decode incoming signal using the PLCM derived from the device identification values. The device identifiers, such as EINs, MEIDs, or IMSIs, are applied in accordance with known techniques and the convention of the macro base station to generate a PLCM for each authorized device. Demodulated signals are decoded using the PLCMs to attempt to decode the incoming signals. In some cases the PLCM maybe assigned by the base station.

At step 804, it is determined if an uplink signal is received from an authorized wireless communication device 108. If an incoming signal is successfully decoded, the controller 616 determines that the detection signal has been received and transmits the pilot signal at step 806. Otherwise, the method returns to step 802 to continue monitoring the uplink channels.

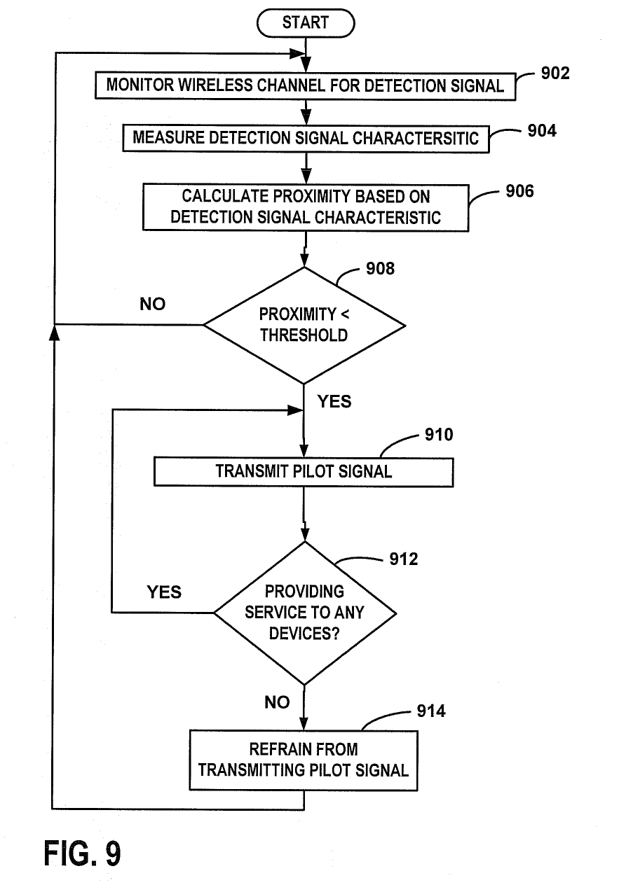

FIG. 9 is a flow chart of a method of managing transmission of pilot signals where the proximity of the wireless communication device 108 to the detecting base station 104 is determined based on the detection signal. The method may be performed by any combination of hardware, software and/or firmware. The order of the steps discussed below may be varied and one or more steps may be performed simultaneously in some circumstances. In the exemplary embodiment, the method is performed, at least in part, by executing code on the controller 616 in the detecting base station 104.

At step 902, the wireless channel that may contain the detection signal is monitored. The wireless communication device detector 122 attempts to demodulate and/or decode incoming signals within the wireless communication channel.

At step 904, a characteristic of the detection signal is measured. One or more parameters such as power level or signal travel time are measured.

At step 906, the proximity of the communication device 108 to the detecting base station 104 is calculated. The proximity calculation may be based on any number of parameters or characteristics of the received detection signal as well as other factors. Examples of suitable parameters include parameters related to signal power level and a timing offset between a transmission and reception times. Other related factors may include transmission power level, location of one or more base stations and information extracted from detection signal and downlink signals such as time stamps, power level indicators, and power control indicators. In some circumstances, the proximity is based only on a detection of the uplink signal as discussed with reference to FIG. 7. The particular factors and calculation techniques depend on the type of communication system 100.

At step 908, it is determined whether the communication device 108 is close enough to the detecting base station 104 to justify transmitting the pilot signal 112. The calculated proximity is compared to the threshold. In the exemplary embodiment, the proximity is determined to be less than the proximity threshold if the detection signal is detected. If the proximity is less than the threshold, the method continues at step 910 where the pilot signal is transmitted. Otherwise, the method returns to step 902. In some circumstances, this step may be omitted and the access point 102 may send proximity information to the core network with other information to allow the system 100 to make the determination of whether a communication device 108 should acquire service from the detecting base station 104 and whether the detecting base station 104 should transmit the pilot signal 112.

At step 912, it is determined whether the base station 104 is providing service to any wireless communication devices. If at least one wireless device 108 is communicating with the base station 104, the method returns to step 910 to continue transmitting the pilot signal. If no wireless communication devices 108 are communicating with the base station 104, the base station 104 stops transmitting the pilot signal at step 914 and returns to step 902

As discussed above, providing wireless service includes providing communication service to devices 108 in active states as well as providing other services to devices in idle states such as, for example, registration and administrative related services. Accordingly, the detecting base station determines whether any wireless communication devices 108 are in active state and communicating with the detecting base station and also determines if any devices are in the idle state. If the detecting base station determines that there are no active devices 108 within the cell, the base station 104 determines whether any idle devices 108 may still be within the cell. The detecting base station may use any of several methods to determine if devices 108 in the idle state are still within range of the detecting base station 104. One suitable example includes a requiring a time-based registration from idle devices where the wireless communication device 108 periodically registers with the detecting base station. If the detecting base station determines that no idle devices are registering, the wireless communication device determines that no devices are receiving wireless service. Another suitable example includes receiving a message from the core network indicating that wireless communication device 108 has registered with another base station such as the originating base station 106, for example. If all previously registered devices are determined to have migrated to other base stations based on the core network messages, the detecting base station 104 determines that no communication devices are receiving wireless service. Another suitable example includes including a request and acknowledgement messaging arrangement where the detecting base station 104 periodically sends an Order Message to devices that may be in an idle state. If no acknowledgement message is received, the detecting base station determines that the device 108 is not longer in the cell. If no previously detected devices 108 are determined to be still within the cell, the detecting base station 104 determines that no wireless communication devices 108 are receiving wireless service and the method continues at step 914 where pilot signal is turned off.

Clearly, other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

What is claimed is:

1. A base station comprising:
a receiver configured to detect a presence of a wireless communication device; and
a transmitter configured to transmit a pilot signal in response to detecting the presence of the wireless communication device.

2. The base station of claim 1, wherein the receiver is configured to detect the presence of the wireless communication device by receiving a detection signal transmitted from the wireless communication device.

3. The base station of claim 2, wherein the detection signal is an uplink communication signal transmitted to another base station.

4. The base station of claim 3, wherein the receiver is configured to decode the uplink signal using a long code mask corresponding to the wireless communication device and where the uplink signal is detected when the uplink signal is successfully decoded.

5. The base station of claim 3, wherein the other base station is a macro base station providing wireless service within a macrocell geographical service area larger than a detecting base station geographical service area of the base station.

6. The base station of claim 5, wherein the detecting base station geographical service area is a femtocell service area within the macrocell geographical service area.

7. The base station of claim 2, wherein the detection signal is a Bluetooth signal transmitted from the wireless communication device.

8. The base station of claim 1, wherein the receiver is configured to receive a detection signal transmitted from the wireless communication device to another base station, the base station further comprising a controller configured to determine a proximity of the wireless communication device to the base station based on at least one characteristic of the detection signal and to detect the presence of the wireless communication device when the proximity is less than a proximity threshold.

9. The base station of claim 1, wherein the pilot signal is communication pilot signal.

10. The base station of claim 1, wherein the pilot signal is a pilot beacon signal.

11. The base station of claim 1, wherein the wireless communication device is an authorized user of the base station.

12. A base station for connecting to a wireless wide area network (WWAN), the base station comprising:
a wireless interface configured to provide wireless communication services to at least one mobile communication device of a plurality of a mobile communication devices authorized to communicate on the WWAN;
a wireless communication device detector configured to receive a detection signal transmitted from the at least one mobile communication device;
a transmitter configured to refrain from transmitting a pilot signal until the detection signal is received.

13. The base station of claim 12, wherein the wireless interface is configured to provide wireless communication services within a first geographical service area and the detection signal is an uplink signal transmitted from the wireless communication device to another base station providing wireless communication services within a second geographical service area larger than the first geographical service area.

14. The base station of claim 13, wherein the first geographical service area is within the second geographical service area.

15. The base station of claim 13, wherein the wireless communication device detector is configured to decode the uplink signal using a long code mask corresponding to the wireless communication device and where transmitter is configured to transmit the pilot signal is response to receiver successfully decoding the uplink signal.

16. The base station of claim 13, wherein the first geographical service area is a femtocell service area and the second geographical service area is a macrocell service area.

17. A method of managing pilot signal transmission from a base station, the method comprising:
detecting a presence of a wireless communication device at a base station; and
transmitting a pilot signal in response to detecting the presence of the wireless communication device.

18. The method of claim 17, wherein the detecting comprises:
receiving, at the base station, a detection signal transmitted from the wireless communication device.

19. The method of claim 18, wherein the receiving comprises:
applying a long code mask corresponding to the wireless communication device to an incoming uplink signal transmitted from the wireless communication device to decode the uplink signal.

20. The method of claim 17, wherein detecting the presence comprises determining a proximity of the wireless communication device to the base station based on a characteristic of a detection signal transmitted from the wireless communication device and determine that the presence has been detected when the proximity is less than a proximity threshold.
